(19) United States
(12) Patent Application Publication
(10) Pub. No.: US 2011/0046833 A1
(43) Pub. Date: Feb. 24, 2011

(54) METHOD FOR DETERMINING THE STARTING TORQUE IN A HYBRID VEHICLE

(76) Inventors: Max Bachmann, Bad Waldsee (DE); Kai Bornträger, Langenargen (DE)

Correspondence Address: BRINKS HOFER GILSON & LIONE, P.O. BOX 10395, CHICAGO, IL, 60610, US

(21) Appl. No.: 12/811,992

(22) PCT Filed: Dec. 8, 2008
(86) PCT No.: PCT/EP08/66982

§ 371 Date: Nov. 4, 2010

(30) Foreign Application Priority Data
Jan. 9, 2008 (DE) 10 2008 000 014.0

(51) Int. Cl. B60W 20/00; B60W 10/02

(52) U.S. Cl. 701/22; 180/65.275; 903/902

(57) ABSTRACT

A method for determining the starting torque in a hybrid vehicle, comprising an internal combustion engine and an electric machine, wherein the internal combustion engine can be decoupled from the drive train by opening a clutch, said method providing for the determination of the starting torque by detecting the holding torque in a holding process of the vehicle with the internal combustion engine decoupled before the operating brake is engaged, wherein the holding torque detected corresponds to the minimum required starting torque.

The present invention relates to a method for determining the starting torque in a hybrid vehicle comprising an internal combustion engine and an electric machine, wherein the internal combustion engine can be decoupled from the drive train by opening a clutch, according to the preamble of patent claim 1.

Vehicles of this type are known from the prior art. They comprise an internal combustion engine and at least one electric machine which are connected in series in this sequence, wherein the internal combustion engine can be decoupled from the electric machine, and therefore from the drive train, by opening a clutch; in this context the transmission input is connected, or can be detachably connected by means of a further clutch, to the output of the electric machine or of a summing gear at which the torques of the electric machine and of the internal combustion engine are summed.

In order to determine the necessary starting torque in order to optimize gear shifting, knowledge of the gradient of the section of road is required; the prior art discloses, for example determining the gradient of the section of road by means of inclination sensors. As an alternative to this, it is known to determine the starting torque dynamically based on a mass determination of the vehicle by means of deceleration values and drive torques. For example, a method and a device for determining the mass of a vehicle are known from DE 19728867 A1. In this context, there is provision for at least a first and a second acceleration value to be detected, wherein these acceleration values represent the vehicle acceleration at a first point in time and at a second point in time.

Furthermore, a first drive value and a second drive value (driving force or starting torque) are detected at the first point in time and at the second point in time, wherein at least a first and a second driving resistance value or mass estimated value are determined as a function of the detected acceleration values and the detected drive values. In the known method there is provision for the mass of the vehicle to be determined by means of a comparison of the specific first driving resistance value or mass estimated value with the specific second driving resistance value or mass estimated value. In this context, an inclination of the roadway is detected by means of this comparison and is used to avoid incorrect determination of mass due to the inclination of the roadway.

Within the scope of DE 10235969 A1 by the Applicant, a method and a device are proposed for controlling a transmission for a motor vehicle having an electronic control unit for setting a transmission ratio which is adapted to a current driving situation, within the scope of which has means for determining a driving resistance by means of a current level of excess torque and a vehicle acceleration which is present at the same time as a function of a signal which is supplied by an inclination sensor and represents an inclination variable of the roadway, and means for determining a vehicle mass by comparing a current excess torque/vehicle acceleration relationship with an excess torque vehicle acceleration characteristic curve which is defined for a specific vehicle mass and is stored as a characteristic diagram or a mathematical formula in the electronic control unit.

The methods which are known from the prior art for dynamically determining the starting torque are complicated and require considerable expenditure.

The invention which is provided is based on the object of specifying a method for determining the starting torque in a hybrid vehicle comprising an internal combustion engine and an electric machine, wherein the internal combustion engine can be decoupled from the drive train by opening a clutch, as a result of the execution of which the starting torque can easily be determined. In particular, the necessity for additional components is to be eliminated.

This object is achieved by means of the features of patent claim 1. Further advantageous refinements and advantages emerge from the subclaims.

Accordingly, it is proposed that the starting torque is determined by detecting the holding torque in a holding process of the vehicle with the internal combustion engine decoupled before the service brake is engaged, wherein the detected holding torque corresponds to the minimum required starting torque.

The difference between the applied torque and the detected holding torque, i.e. the excess torque accordingly serves exclusively to start or accelerate the vehicle. The starting torque is advantageously determined with a high level of accuracy without the need for costly determination of the gradient and mass.

According to the invention, in order to detect the holding torque of the vehicle, the electric machine whose output is connected directly to the transmission input or via a summing gear is actuated in such a way that the stationary state of the vehicle is maintained, wherein the holding torque is determined from the known relationship between the torque of the electric machine and the electrical variables at the power inverter of the electric machine. If the output of the electric machine or of the summing gear is connected to the transmission input by means of a clutch, this clutch is closed.

The value of the holding torque is preferably stored in a non volatile memory of the controlling means so that when the vehicle is started again said value can be used to leave the holding position or parking position, and when the holding torque is detected again, which may be the case when the vehicle stops again, the value is overwritten.

According to one advantageous development of the invention it is possible to provide that starting is performed purely electrically or with the internal combustion engine connected depending on the driving strategy and the value of the detected holding torque, wherein if the internal combustion engine is to be connected by closing the clutch which is arranged between the internal combustion engine and the electric machine, according to the invention the internal combustion engine can already be started when the door closing signal occurs if the internal combustion engine is switched off at this time.

If, for example, the value of the holding torque is lower than the torque which can be made available by the electric motor and a low acceleration is desired, the starting process is carried out in the purely electric mode. If the detected holding torque is higher than the maximum torque of the electric motor, the internal combustion engine is connected in order to carry out the starting process.

By virtue of the conception according to the invention, the minimum value of the necessary starting torque is easily determined with a high level of accuracy without the need for additional components such as, for example, inclination sensors, wherein the need to carry out determination of the mass of the vehicle is also eliminated. The method which is proposed here can advantageously be carried out in a vehicle comprising an integrated starter generator (ISG) with a clutch which is arranged between the internal combustion engine and the electric machine of the starter generator.

1. A method for determining the starting torque in a hybrid vehicle comprising an internal combustion engine and an electric machine, wherein the internal combustion engine can be decoupled from the drive train by opening a clutch, characterized in that the starting torque is determined by detecting the holding torque in a holding process of the vehicle with the internal combustion engine decoupled before the service brake is engaged, wherein the detected holding torque corresponds to the minimum required starting torque.

2. The method for determining the starting torque in a hybrid vehicle as claimed in claim 1, characterized in that, in order to detect the holding torque of the vehicle, the electric machine whose output is connected directly to the transmission input or via a summing gear is actuated in such a way that the stationary state of the vehicle is maintained, wherein the holding torque is determined from the known relationship between the torque of the electric machine and the electrical variables at the power inverter of the electric machine.

3. The method for determining the starting torque in a hybrid vehicle as claimed in claim 2, characterized in that starting is carried out purely electrically or with the internal combustion engine connected depending on the driving strategy and the value of the holding torque.

4. The method for determining the starting torque in a hybrid vehicle as claimed in claim 3, characterized in that if the internal combustion engine is to be connected by closing the clutch which is arranged between the internal combustion engine and the electric machine, the internal combustion engine can already be started when the door closing signal occurs if the internal combustion engine is switched off at this point in time.

5. The method for determining the starting torque in a hybrid vehicle as claimed in claim 1, characterized in that the value of the holding torque is stored in a non volatile memory of the controlling means so that it can be used when the vehicle is started again.
